(19) United States
(12) Patent Application Publication
(10) Pub. No.: US 2016/0360418 A1
(43) Pub. Date: Dec. 8, 2016

(54) UNAUTHORIZED BEACON DETECTION

(71) Applicant: International Business Machines Corporation, Armonk, NY (US)

(72) Inventors: Qiang Guan, Scarborough (CA); He Yuan Huang, BEIJING (CN); Chun hua Tian, Beijing (CN); Feng Juan Wang, Beijing (CN); Yu Wang, Beijing (CN); Zhi Jun Wang, Beijing (CN); Chao Zhang, Beijing (CN)

(21) Appl. No.: 15/055,665

(22) Filed: Feb. 29, 2016

Related U.S. Application Data
(63) Continuation of application No. 14/730,301, filed on Jun. 4, 2015.

(51) Int. Cl. H04W 12/12; H04W 4/02; H04W 48/16

(52) U.S. Cl. CPC H04W 12/12; H04W 48/16; H04W 4/023; H04W 4/028

(57) ABSTRACT

A method to detect unauthorized beacons includes receiving position information that defines a positional pattern for a plurality of authorized beacons, receiving beacon identifiers from a plurality of beacons with a beacon receiving device, determining a movement path of the beacon receiving device relative to the positional pattern, and determining whether the movement path has an anomaly. A corresponding computer program product and computer system are also disclosed herein.

### BACKGROUND OF THE INVENTION

The present invention relates generally to the device validation and more particularly to validation of beacon devices.

Beacons enable electronic devices to determine their approximate position without requiring access to satellite signals and provide a location dependent experience to the users of beacon receiving devices. For example, electronic devices that are equipped to receive and decode beacon signals may be used within retail establishments equipped with beacons to provide an enhanced experience to customers. For example, beacon enabled electronic devices may provide information about, or coupons for, specific products which are proximate to a user of the beacon enabled electronic device.

Despite the foregoing, unauthorized beacons may be introduced into a beacon enabled environment inadvertently, or maliciously by someone who wishes to disrupt the improved customer experience. The presence of unauthorized devices can degrade or inhibit the customer experience by mimicking an authorized device at a position that is different than the position of the authorized device. As a result, the position of the beacon receiving device may be incorrectly estimated. Consequently, the presence of unauthorized devices presents a challenge to the acceptance of beacon devices and the associated improvement in the customer experience.

### SUMMARY

A method to detect unauthorized beacons includes receiving position information that defines a positional pattern for a plurality of authorized beacons, receiving beacon identifiers from a plurality of beacons with a beacon receiving device, determining a movement path of the beacon receiving device relative to the positional pattern, and determining whether the movement path has an anomaly. A corresponding computer program product and computer system are also disclosed herein.

### BRIEF DESCRIPTION OF THE DRAWINGS

FIG. 1 is a floorplan diagram depicting one example of an environment in which at least one embodiment of the present invention may be deployed;

FIG. 2 is a map diagram depicting one example of the effect of an unauthorized beacon on user received beacon identification information;

FIG. 3 is a flowchart depicting an anomaly detection method in accordance with at least one embodiment of the present invention;

FIGS. 4A and 4B depict, respectively, one example of a zone transition map and one example of a zone transition table in accordance with at least one embodiment of the present invention;

FIG. 4C is text diagram depicting one example of detecting unauthorized beacons in accordance with at least one embodiment of the present invention;

FIG. 5A is a map and FIG. 5B is a table depicting one example of how beacon derived positional estimates may be leveraged to detect unauthorized beacons in accordance with at least one embodiment of the present invention;

FIG. 6A is a map and FIG. 6B is a table depicting one example of how sensor derived positional estimates may be leveraged to detect unauthorized beacons in accordance with at least one embodiment of the present invention; and

FIG. 7 is a block diagram depicting one example of a computing apparatus (e.g., computer) suitable for executing the methods disclosed herein.

### DETAILED DESCRIPTION

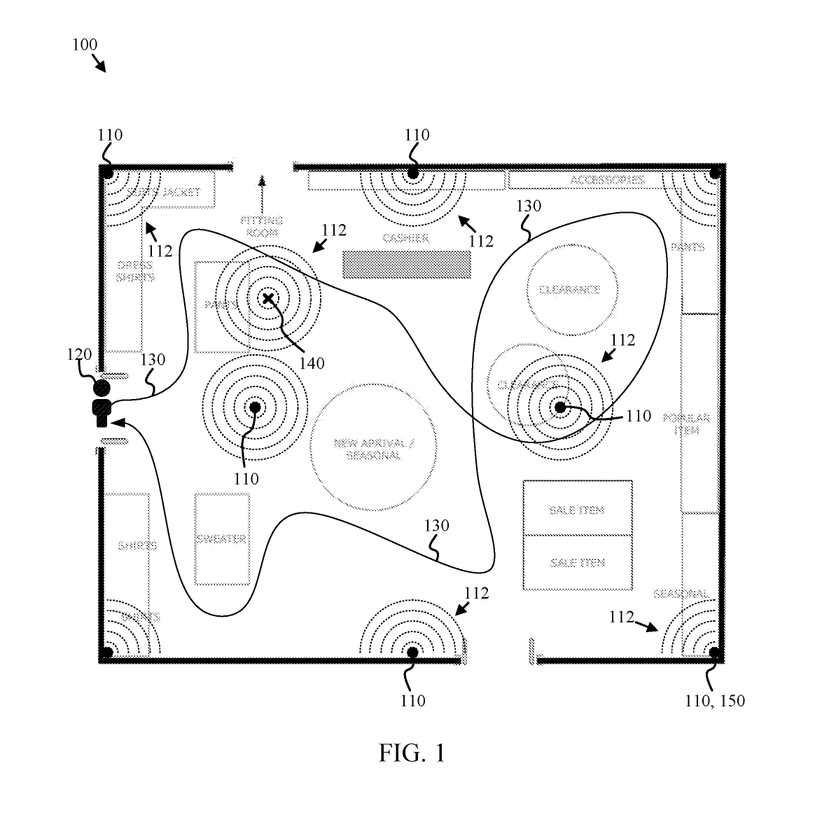

The embodiments disclosed herein enable the detection of unauthorized devices in a beacon enabled environment. For example, FIG. 1 is a floorplan diagram depicting one example of a beacon environment 100 in which at least one embodiment of the present invention may be deployed. As depicted, the beacon environment 100 includes one or more authorized beacons 110 placed at selected positions within the environment 100. Each authorized beacons 110 may broadcast a signal 112 with a unique beacon identifier (not shown) embedded therein.

The signals 112 emitted by the authorized beacons 110 may enable a user 120 to move through the beacon environment 100 (e.g., along a selected movement path 130) and receive beacon identification information from the authorized beacons 110 with a beacon receiving device (not shown) such as a cell phone or tablet. The beacon identification information may enable the beacon receiving device to provide position dependent information or interactions to the user 120. For example, information regarding products that are currently proximate to the user may be provided to the user by a server (not shown) that communicates to the beacon receiving device via a wireless network (not shown). In some embodiments, the relative strength of the signals 112 are leveraged in determining an estimated position of a beacon receiving environment within the beacon environment 100.

One issue for the beacon environment 100 is the introduction of unauthorized beacons 140. Each unauthorized beacon 140 may emit a signal 112 that has beacon identification information that is identical to that of a mimicked beacon 150. The depicted beacon environment 100 includes a single unauthorized beacon 140 which mimics the mimicked beacon 150. The unauthorized beacons 140 may confuse and even incapacitate the beacon receiving device of the user 120.

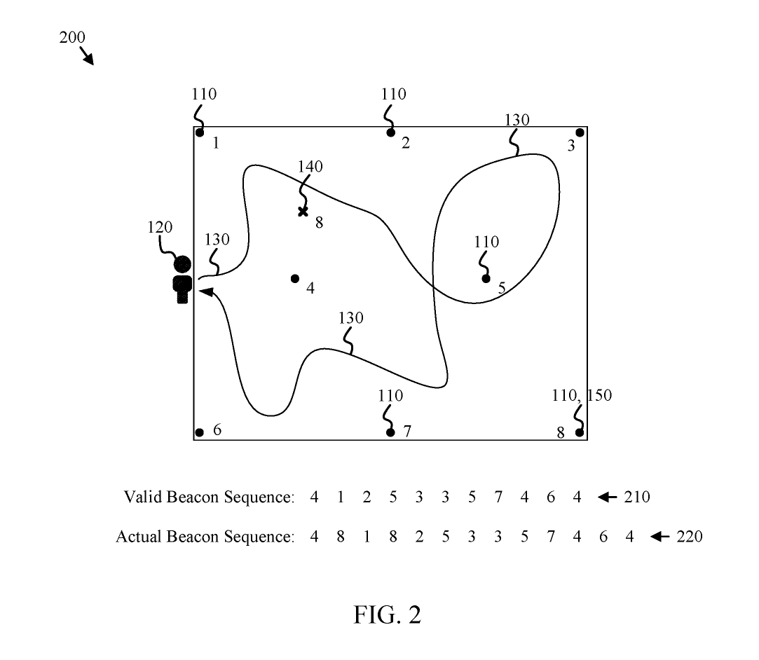

FIG. 2 is a map diagram depicting one example 200 of the effect of an unauthorized beacon 140 on received beacon identification information. The depicted example 200 corresponds to the beacon environment 100 depicted in FIG. 1 and includes a single unauthorized beacon 140 which transmits a beacon identifier (i.e., “8”) that is identical to the beacon identifier transmitted by the mimicked beacon 150. As shown in the example 200 depicted in FIG. 2, a user 120 that follows the depicted movement path 130 should receive a valid beacon sequence 210. However, due to the presence of the unauthorized beacon 140 the user 120 receives an actual beacon sequence 220 that is different than the valid beacon sequence 210.

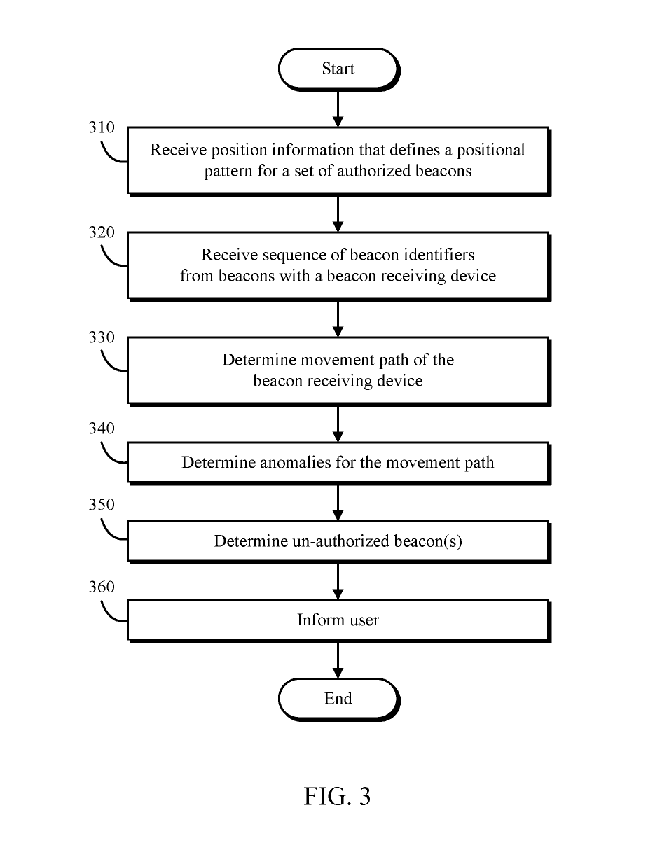

The present invention enables the detection of unauthorized beacons. For example, FIG. 3 is a flowchart depicting an anomaly detection method 300 in accordance with at least one embodiment of the present invention. As depicted, the anomaly detection method 300 includes receiving (310) position information, receiving (320) a sequence of beacon identifiers, determining (330) a movement path, determining (340) anomalies for the movement path, determining (350) one or more un-authorized beacons, and informing (360) a user. The anomaly detection method 300 may be executed by a beacon enabled mobile device or by a server that communicates with such devices.

Receiving (310) position information may include receiving position information that defines a positional pattern of a set of authorized beacons associated with an environment. In one embodiment, the position information of each authorized beacon included in the positional pattern may be provided by textual input. In another embodiment, a user may enter the position information for each beacon receiving device by clicking on a displayed map representing the local environment. The position information for the authorized beacons may be normalized to a specific reference frame and retained for subsequent use.

Receiving (320) a sequence of beacon identifiers may include receiving, with a beacon receiving device, a sequence of beacon identifiers encountered along a movement path. In some embodiments, relative signal strength of a transmitted signal is recorded by the beacon receiving device. In some embodiments, the strength of the signals that are received by the beacon receiving device are recorded as a function of time. In certain embodiments, the beacon receiving device may be provided with a positional sensor such as an accelerometer than enables recording beacon signal strength as a function of position. The recorded signal strength information may enable improved positional estimates for the beacon receiving device and/or improved detection of movement path anomalies.

Determining (330) a movement path may include using the sequence of beacon identifiers along with the position information for the authorized beacons and/or any other source of position information to determine the movement of the beacon receiving device over time. The movement path may be normalized to the same frame of reference as the position information for the authorized beacons. In some embodiments, the movement path is simply the sequence of beacon identifiers.

Determining (340) anomalies for the movement path may include determining whether there are discontinuities, jumps, or inconsistencies in the movement path. Examples include an invalid transition in the sequence of beacon identifiers, a jump in an estimated position, or a discrepancy between an estimated position of the beacon receiving device and the position of an authorized beacon that corresponds to a beacon identifier. In some embodiments, time or duration information is used to detect time intervals or velocities for zone transitions that are outside of a reasonable range.

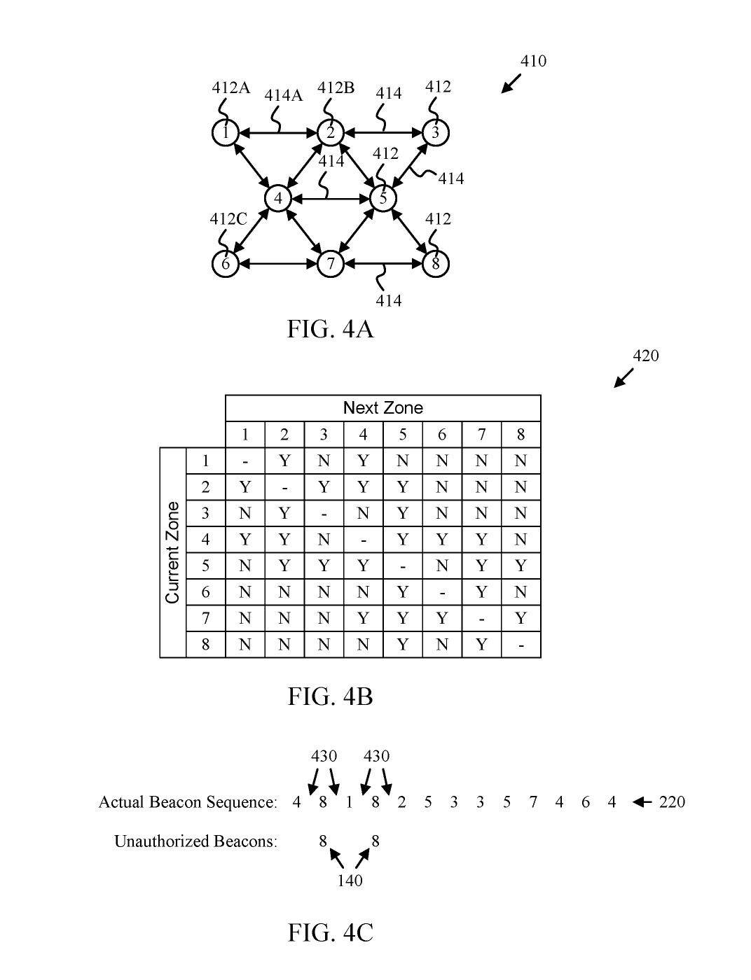

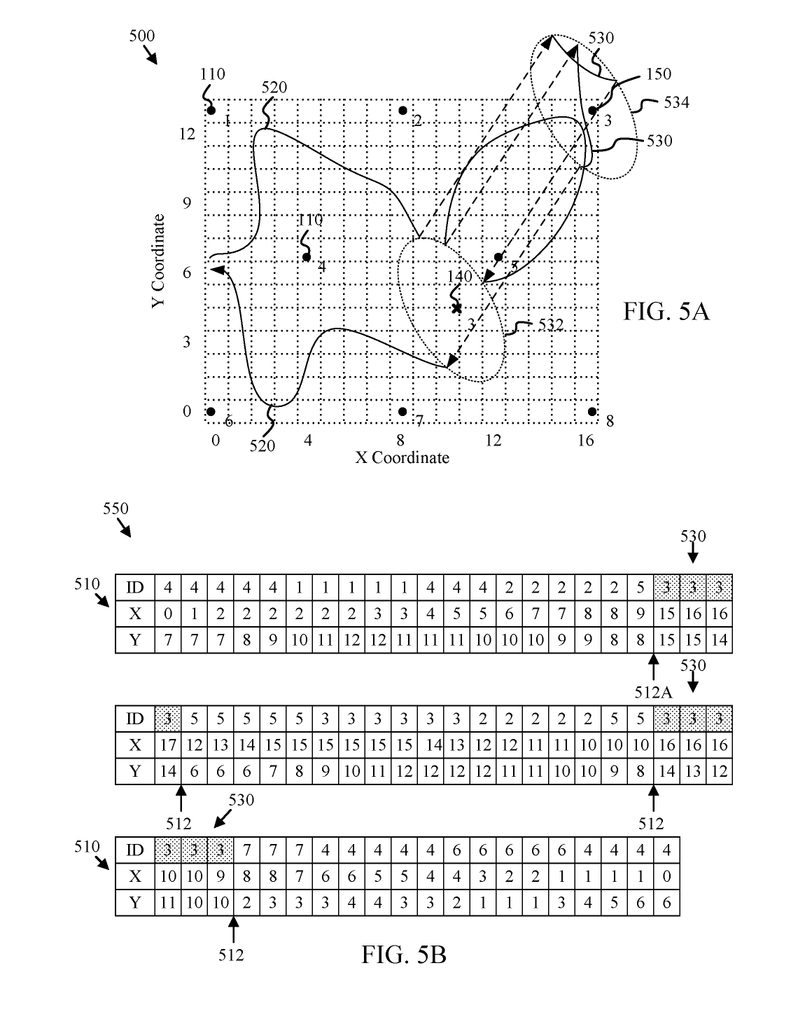

Determining (350) one or more un-authorized beacons may include determining mimicked beacon identifiers that correspond to anomalies for the movement path. See the description of FIGS. 4C, 5A, and 5B for specific examples of how mimicked beacon identifiers may be determined. In some embodiments, beacon identifiers that repeatedly correspond to anomalies are assumed to be mimicked beacon identifiers. Informing (360) a user may include providing information regarding the anomalies for the movement path, beacon identifiers that are mimicked, and an estimated position of the unauthorized (i.e., mimicking) beacons to a system administrator, or the like. The information may be presented on a terminal or a mobile device used by the system administrator or another user. For example, a server associated with managing the beacons may display the information on a terminal or transmit a message to a mobile device equipped with an application that communicates with the server.

FIGS. 4A and 4B depict, respectively, one example of a zone transition map 410 and one example of a zone transition table 420 in accordance with at least one embodiment of the present invention. The zone transition map 410 and the zone transition table 420 indicate which beacon zones in an environment are adjacent to each other. The zone transition map 410 and the zone transition table 420 enable the detection of invalid zone (i.e., beacon identifier) transitions such as those associated with movement path anomalies. The zone transition map 410 and the zone transition table 420 may be used in the determining operations 340 and 350 depicted in FIG. 3.

The zone transition map 410 includes a set of nodes 412 and a set of links 414. The zone transition map 410 may be generated by user input or generated automatically from the position information received in step 310 of FIG. 3 based on the estimated transmission range of beacons. The nodes 412 correspond to authorized beacons and the links 414 indicate valid transitions. For example, a link 414A that connects the node 412A to the node 412B indicates that a transition between the zones corresponding to the two nodes is valid (i.e., a transition from zone 1 to zone 2). In contrast, the depicted zone transition map 410 does not have a link between node 412A and node 412C indicating that a transition between the zones corresponding to the two nodes is invalid (i.e., a transition from zone 1 to zone 6).

Similar to the zone transition map 410, the zone transition table 420 indicates which zone transitions are valid and which are invalid. The zone transition table 420 may be generated by user input or generated automatically from the position information received in step 310 of FIG. 3 based on the estimated transmission range of beacons. In the depicted zone transition table 420 a ‘current’ zone corresponds to a row in the table and a ‘next’ zone corresponds to a column in the table. The entry at the intersection of the particular row and column indicates whether a transition from the current zone to the next zone is valid. In the depicted embodiment, valid transitions are indicated with a “Y” symbol and invalid transitions are indicated with a “N” symbol.

FIG. 4C is text diagram depicting one example of detecting unauthorized beacons in accordance with at least one embodiment of the present invention. Transitions in the actual beacon sequence received by a beacon enabled electronic device operated by a user may be tested for validity using the zone transition map 410, the zone transition table 420, or the like. The depicted example includes four invalid transitions 430 that may be identified using the zone transition map 410 or the zone transition table 420. Furthermore, beacon identifiers for unauthorized beacons may be found by testing whether a transition that skips a beacon identifier (i.e., zone) results in a valid transition. For example, while transitions between zones 4 and 8, zones 8 and 1, zones 1 and 8, and zones 8 and 2 are invalid, transitions between zones 4 and 1, and zones 1 and 2 are valid. Consequently, beacon identifier 8 may be marked as potentially corresponding to an unauthorized beacon 140 in the depicted beacon identifier sequence. In some embodiments, beacon identifiers that are repetitively marked as potentially corresponding to an unauthorized beacon 140 (such as beacon identifier 8 in the depicted example) result in the generation of a report to a user. In certain embodiments, unauthorized beacons are tracked over time to facilitate analysis and future detection.

FIG. 5A is a map 500 and FIG. 5B is a table 550 depicting one example of how beacon derived positional estimates 510 collected over time may be leveraged to detect unauthorized beacons in accordance with at least one embodiment of the present invention. In some embodiments, the absolute or relative signal strength of beacons may be used to provide the positional estimates 510 for the user as shown in FIG. 5B. In certain embodiments, time or duration information may be recorded along with the positional estimates 510 to enable the detection of anomalies. The positional estimates may be tracked to form a movement path 520. In the depicted example the map 500 shows how a user 120 that follows the movement path 130 shown in FIGS. 1 and 2 may have one or more anomalous sections 530 in the movement path 520 that are positionally shifted.

In the depicted example, the anomalous sections 530 are positionally shifted from a region 532 around the unauthorized beacon 140 to a region 534 around the mimicked beacon 150. As a result, the positional estimate 510 may undergo an anomalous shift 512 (e.g., that is uncharacteristically large between adjacent positional estimates 510) that indicates an anomaly in the movement path 520. In one embodiment, positional changes that are greater than a selected distance are considered anomalous. As depicted, the anomalous shifts 512 may occur in both the X and Y components of the positional estimate 510 or just the X or Y component. Due to the anomalous shifts 512, an anomaly in the movement path may be detected despite valid transitions in the beacon identifiers. For example, in the depicted example an anomalous shift 512A is detected despite a valid transition between beacon zone 5 and beacon zone 3.

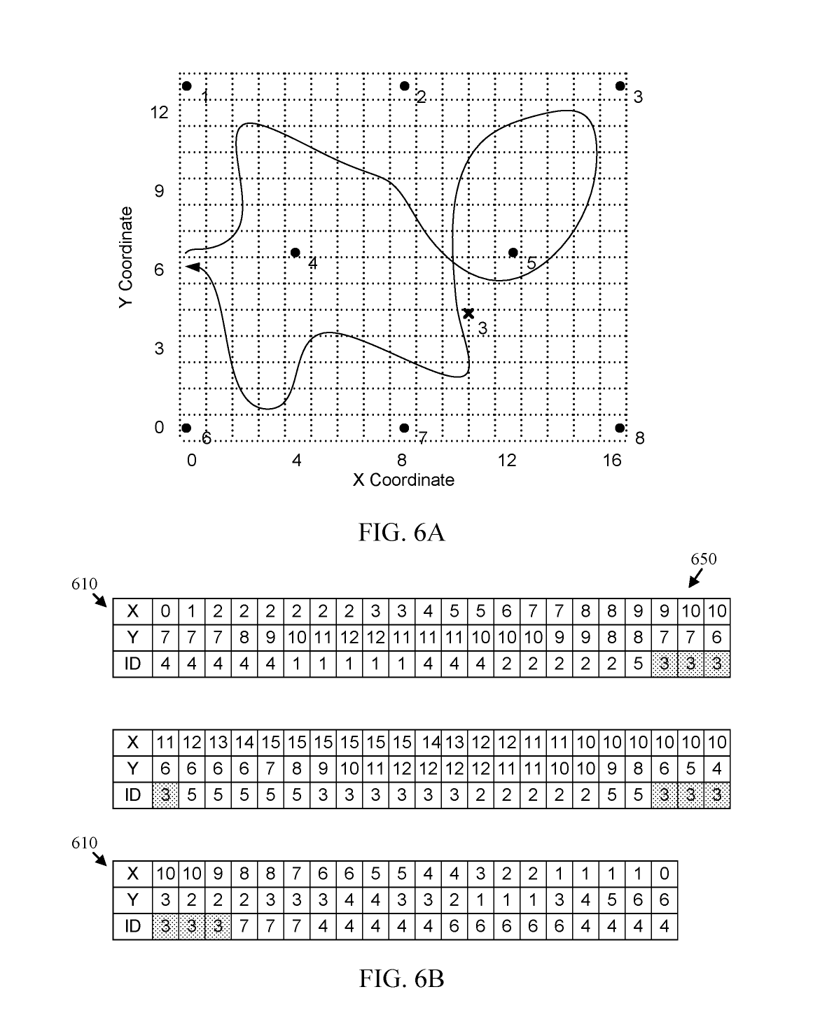

FIG. 6A is a map 600 and FIG. 6B is a table 650 depicting one example of how sensor derived positional estimates 610 may be leveraged to detect unauthorized beacons in accordance with at least one embodiment of the present invention. In the depicted example, the sensor derived positional estimates 610 are derived (at least in part) from measurements that are substantially independent of the beacon identifiers (i.e., not extracted from beacon signals) and are therefore not subject to corruption by unauthorized beacons. For example, a sensor on the beacon receiving device used by the user, such as an accelerometer, may be used to derive the positional estimates 610. In certain embodiments, time or duration information may be recorded along with the positional estimates 610 to enable the detection of anomalies.

The positional estimates 610 may be compared with the positional information for the authorized beacons 110 to detect discrepancies that may be otherwise difficult to detect. For example, the shaded beacon identifier entries within the table 650 may correspond to (anomalous) positions that are outside the zone indicated by the beacon identifier. Consequently, the shaded entries may be identified as corresponding to an unauthorized beacon, which in the depicted example is a beacon with a beacon ID of “3”. In one embodiment, the positional estimates 610 for each unauthorized beacon are averaged to provide an estimated location for the particular unauthorized beacon. The estimated location of the unauthorized beacon along with the beacon identifier may be provided by the user to facilitate removal of the unauthorized beacon.

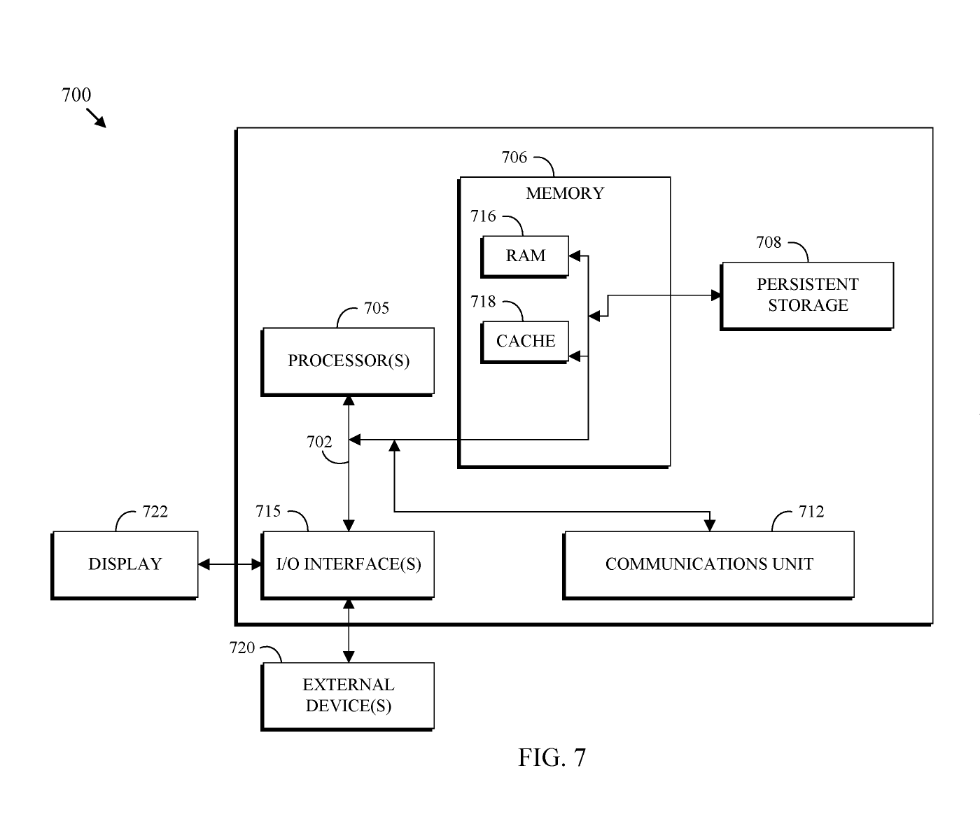

FIG. 7 is a block diagram depicting components of a computer 700 suitable for executing the methods disclosed herein. The computer 700 may be one embodiment of a beacon receiving device or a server associated with the beacon environment 100. It should be appreciated that FIG. 7 provides only an illustration of one embodiment and does not imply any limitations with regard to the environments in which different embodiments may be implemented. Many modifications to the depicted environment may be made.

As depicted, the computer 700 includes communications fabric 702, which provides communications between computer processor(s) 705, memory 706, persistent storage 708, communications unit 712, and input/output (I/O) interface(s) 715. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer readable storage media. In the depicted embodiment, memory 706 includes random access memory (RAM) 716 and cache memory 718. In general, memory 706 can include any suitable volatile or non-volatile computer readable storage media.

One or more programs may be stored in persistent storage 708 for execution by one or more of the respective computer processors 705 via one or more memories of memory 706. The persistent storage 708 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 712, in these examples, provides for communications with other data processing systems or devices. In these examples, communications unit 712 includes one or more network interface cards. Communications unit 712 may provide communications through the use of either or both physical and wireless communications links.

I/O interface(s) 715 allows for input and output of data with other devices that may be connected to computer 700. For example, I/O interface 715 may provide a connection to external devices 720 such as a keyboard, keypad, a touch screen, and/or some other suitable input device. External devices 720 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 708 via I/O interface(s) 715. I/O interface(s) 715 may also connect to a display 722. Display 722 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that this description is not intended to limit the invention. On the contrary, the embodiments presented are intended to cover some of the alternatives, modifications, and equivalents, which are included in the spirit and scope of the invention as defined by the appended claims. Further, in the detailed description of the disclosed embodiments, numerous specific details are set forth in order to provide a comprehensive understanding of the claimed invention. However, one skilled in the art would understand that various embodiments may be practiced without such specific details.

Although the features and elements of the embodiments disclosed herein are described in particular combinations, each feature or element can be used alone without the other features and elements of the embodiments or in various combinations with or without other features and elements disclosed herein. It should also be noted that, as used herein, the term “or” refers to every logical combination of two options. For example, the phrase “A or B” is essentially identical to the phrase “(A and not B) or (B and not A) or (A and B)”.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method, executed by at least one processor, to detect unauthorized beacons, the method comprising:
receiving beacon identifiers from a plurality of beacons with a beacon receiving device to provide a sequence of encountered beacon identifiers;
determining whether the sequence of encountered beacon identifiers has an anomaly;
determining an identifier for an unauthorized beacon that corresponds to the anomaly;
determining an estimated location for the unauthorized beacon;
responsive to determining that the movement path has an anomaly informing a user of the anomaly and the estimated location for the unauthorized beacon; and
wherein determining whether the sequence of encountered beacon identifiers has an anomaly comprises determining whether each sequential pair of beacon identifiers within the sequence of encountered beacon identifiers is specified as a valid beacon identifier pair within a beacon zone transition table, and wherein the beacon zone transition table is indexed using a current beacon zone identifier and a next beacon zone identifier.
